(19) United States
(12) Patent Application Publication
(10) Pub. No.: US 2025/0298687 A1
(43) Pub. Date: Sep. 25, 2025

(54) Computer System, Computer-Implemented Method, and Computer Readable Media For Error Handling When Prompting A Large Language Model (LLM)

(71) Applicant: Shopify Inc., Ottawa (CA)

(72) Inventors: Cody MAZZA-ANTHONY, Toronto (CA); Eric Andrew FLORENZANO, San Francisco, CA (US)

(73) Assignee: Shopify Inc., Ottawa (CA)

(21) Appl. No.: 18/738,705

(22) Filed: Jun. 10, 2024

Related U.S. Application Data
(60) Provisional application No. 63/567,259, filed on Mar. 19, 2024.
(60) Provisional application No. 63/640,343, filed on Apr. 30, 2024.

(51) Int. Cl. G06F 11/07

(52) U.S. Cl. CPC G06F 11/0793

(57) ABSTRACT

A system and method are provided for handling errors when prompting large language models (LLMs). The method includes parsing an indication of a first error to determine corrective information for remedying the first error. The first error is responsive to a command generated by an LLM responsive to prompting the LLM with a first input. The method also includes providing the corrective information causing prompting of the LLM with a second input.

### CROSS-REFERENCE TO RELATED APPLICATIONS

This application claims priority to U.S. Provisional Application Nos. 63/567,259 filed on Mar. 19, 2024, and 63/640,343 filed on Apr. 30, 2024, the entire contents of which are hereby incorporated by reference.

### TECHNICAL FIELD

The following relates generally to prompting LLMs and, in particular, to handling errors when prompting such LLMs, for example, to salvage exchanges with the LLM being used to determine information.

### BACKGROUND

LLMs are increasingly used in performing tasks such as obtaining information, e.g., to determine a command or instruction. For example, an LLM may be prompted to support a chat session wherein input sent to the LLM may include a prompt as well as the text provided by the correspondent engaging in the chat session.

### BRIEF DESCRIPTION OF THE DRAWINGS

Embodiments will now be described with reference to the appended drawings wherein:

FIG. 1 is an example of a computing environment in which an application module prompts an LLM to determine information for an application.

FIG. 2a is an example of a configuration for interacting with the LLM.

FIG. 2b is another example of a configuration for interacting with the LLM.

FIG. 3 is an example of a computing device operable to communicate in the computing environment.

FIG. 4 is a flow chart illustrating example operations for error handling in prompting an LLM.

FIG. 5 is a flow chart illustrating example operations for prompting an LLM to remedy an error to salvage an exchange with an entity that utilizes the LLM.

FIG. 6 is a flow chart illustrating example operations for utilizing an error detection service to detect an error in a response from an LLM.

FIG. 7 is a flow chart illustrating example operations for determining corrective information for a subsequent prompt to an LLM.

FIGS. 8 and 9 show an example of a chat user interface showing a conversation that invokes a prompt to an LLM.

FIG. 10 illustrates an example error message.

FIG. 11 illustrates another example error message.

FIG. 12 is a block diagram of a simplified convolutional neural network, which may be used in examples of the present disclosure.

FIG. 13 is a block diagram of a simplified transformer neural network, which may be used in examples of the present disclosure.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

When utilizing an LLM to obtain information such as a command, the output of the LLM may be used to perform further actions such as invoking an application programming interface (API) or calling a system service. To perform such an action the format/syntax of the output from the LLM typically needs to be correct. However, in some cases, the LLM output is incorrect. Incorrect outputs, and/or errors caused by such incorrect outputs, particularly in a chat session, should not be passed back to the correspondent.

To process LLM outputs, output parsers may be used, which intercept the output of the LLM and perform a check. However, output parsers may need to be developed to account for each expected output, which limits the ability for services that utilize the LLM to scale. Even if an output parser is provided with an error message and an incorrect output, it has been found that the error message itself may often not be enough to resolve the error when creating a subsequent LLM call, particularly when querying legacy services or APIs.

The system described in this disclosure may be implemented to salvage a message exchange with an LLM (e.g., used in a chatbot conversation), by utilizing corrective information based on a first error generated when prompting the LLM, to generate a second LLM call that utilizes the corrective information.

While existing output parsers may detect an errant output from an LLM and perform a retry or subsequent LLM call (which may include providing an error message), an opportunity exists to recover more of the previously unsalvageable exchanges with the LLM. The error message may provide sufficient information to remedy an error some of the time. However, in some instances, the error message itself may not provide sufficient information for the LLM to be successful in a subsequent call. This may occur because the LLM relies on a training set that does not understand the error or have knowledge of the error. To address this challenge, the system described herein may provide more context around the error, by determining and providing corrective information to give the LLM a higher chance of successfully salvaging the exchange. That is, the system may provide information about how to correct the error, and not only what the error is or is called.

Whether the error is detected and returned by the LLM or a separate service utilizing the LLM, the LLM as used by a service, application, module, controller, or other entity, may not be tuned for all errors. Moreover, these LLMs may be large and thus it may be too computationally expensive to update and fine tune the main model being used for error handling, particularly as new errors are discovered. Furthermore, LLMs may be trained on one type of syntax but used with a query that utilizes a different type of syntax. Similar issues may arise with versioning an application.

To address these additional challenges, a corrective service may be deployed alongside or with the LLM being used by an entity, to provide a smaller and more agile corrective mechanism. The corrective service may utilize a look up table; may obtain, create and/or train a corrective model; or otherwise perform a search for corrective information to supplement data associated with an error such as an error message generated by the output returned by the LLM. The corrective service may originate as a query or look up table and evolve over time to generate and train a model, i.e., a so-called “side model” (e.g., another LLM) that may be fine-tuned for error handling. This avoids the need to refine the main LLM being prompted, which may be computationally expensive and may be difficult to achieve.

When deployed, e.g., with a chat service or other message exchange, the corrective service may allow for multiple attempts to salvage a query such as a conversation (e.g., question, request, instruction). The side model and/or look up table utilized by the corrective service may be trained to support conversions between syntax types or be retrained to account for new versions that the main LLM being prompted may not have been trained on.

The corrective service may additionally capture logging data that may be used for ongoing or subsequent/future training or re-training of the main model to account for error handling performed using the side model.

In one aspect, there is provided a computer-implemented method, comprising parsing an indication of a first error to determine corrective information for remedying the first error, the first error responsive to a command generated by an LLM responsive to prompting the LLM with a first input; and providing the corrective information causing prompting of the LLM with a second input.

In certain example embodiments, the method further includes obtaining further input generated by the LLM responsive to the second input.

In certain example embodiments, the method further includes detecting the first error by calling a service to evaluate a first output from the LLM in response to the first input, the service identifying the indication of the first error.

In certain example embodiments, the second input further comprises at least one of the first input and an errant first output.

In certain example embodiments, the indication of the first error is provided in addition to the corrective information in causing the prompting of the LLM with the second input.

In certain example embodiments, the indication of the first error comprises an error message.

In certain example embodiments, parsing the indication of the first error to determine the corrective information comprises referencing a model.

In certain example embodiments, the model comprises a second LLM prompted by a correction service utilized to parse the indication of the first error.

In certain example embodiments, parsing the indication of the first error to determine the corrective information comprises accessing information provided by a third-party source.

In certain example embodiments, parsing the indication of the first error to determine the corrective information comprises conducting a search using one or more searching tools provided by the third-party source.

In certain example embodiments, the method further includes detecting a second error generated by the LLM in response to prompting the LLM with the second input; and outputting at least one of the first error and the second error.

In certain example embodiments, the method further includes parsing an indication of a second error to determine additional corrective information for remedying at least one of the first error and the second error, the second error responsive to the corrected command generated by the LLM responsive to prompting the LLM with the second input; and providing the additional corrective information causing prompting of the LLM with a third input.

In certain example embodiments, the method further includes obtaining further input generated by the LLM responsive to the third input.

In certain example embodiments, the indication of the second error is provided in addition to the corrective information in causing the prompting of the LLM with the third input.

In another aspect, there is provided a computer system. The computer system includes at least one processor and at least one memory. The at least one memory includes processor executable instructions that, when executed by the at least one processor, cause the computer system to parse an indication of a first error to determine corrective information for remedying the first error, the first error responsive to a command generated by an LLM responsive to prompting the LLM with a first input; and provide the corrective information causing prompting of the LLM with a second input.

In certain example embodiments, the computer system further includes instructions that, when executed by the at least one processor, cause the computer system to: obtain further input generated by the LLM responsive to the second input.

In certain example embodiments, the computer system further includes instructions that, when executed by the at least one processor, cause the computer system to detect the first error by calling a service to evaluate a first output from the LLM in response to the first input, the service identifying the indication of the first error.

In certain example embodiments, the second input further comprises at least one of the first input and an errant first output.

In certain example embodiments, the indication of the first error is provided in addition to the corrective information in causing the prompting of the LLM with the second input.

In another aspect, there is provided a computer-readable medium. The computer-readable medium includes processor executable instructions that, when executed by a processor of a computer system, cause the computer system to: parse an indication of a first error to determine corrective information for remedying the first error, the first error responsive to a command generated by an LLM responsive to prompting the LLM with a first input; and provide the corrective information causing prompting of the LLM with a second input.

The corrective service may be implemented with other functions, modules, services, applications, or programs to facilitate error detection, corrective information retrieval and/or execution of operations to support an entity that utilizes the LLM in an exchange of data, such as in a chat session or information query source. The corrective service may be incorporated into various user experience (UX) features, such as how to visualize corrections that are occurring in real-time during a chat conversation, e.g., to parse the entire message before beginning to display the response (which may be corrected on the fly).

In an example, the corrective service may employ an error detection module to account for parsing of an LLM output to determine the existence of the errors prior to determining corrective information. This may include calling external services to determine if the command or other information provided by the LLM in response to a prompt will work and/or will generate the appropriate response for the entity utilizing the LLM. The corrective information may be provided in a second LLM prompt along with various optional information, such as the error message, the original input, the incorrect output, or other contextual data. The following summarizes a multi-run LLM query using the corrective service.

1. LLM First Run Input—provide original instructions.

2. LLM First Run Output—receive errant initial output, determine or receive information indicative of an error such as an error message.

3. Use the information regarding error (e.g., error message) to look up corrective information (e.g., look-up-table, model, database, semantic search, etc.).

4. LLM Second Run Input—corrective information, potentially with following optional information: original Instructions, errant initial output, error message.

5. LLM Second Run Output—correct output (if salvageable) or errant second output (if unsalvageable).

Optionally, the process may repeat one or more additional times until the output is salvageable or deemed to be unsalvageable.

In some cases, the second call to the LLM is to the same model, and in other cases it may be to a different model (e.g., a newer version, a higher parameter version, higher quantized version, different model altogether, etc.). The second call may be to a specialized model chosen based in some part on the error message received due to the output from the first model. For example, a code generation model or a model fine-tuned on GraphQL API schemas and queries.

In cases where the conversation is salvaged, after the second LLM output is received, a response may be sent to the user. There may also be additional outputs such as a navigation user interface (UI), a form, a prefilled form, etc. In cases where the conversation is unsalvageable, after the second LLM output is received, an error message may be sent to the user. This error message may ask the user to try again, may inform the user to retry, etc. Alternatively, if the conversation is deemed unsalvageable, a chatbot may abandon the conversation. Further alternatively, if the conversation is deemed unsalvageable, the chatbot may escalate the conversation/exchange to an operator. The determination that the conversation is unsalvageable may be based on whether the second LLM output contains an error, contains a different error than the first LLM, contains the same error as the first LLM, etc. In some cases, if the second output overcame the error in the first output but has a further error, another (third or more) LLM call(s) may be produced with a second (or more) corrective information. This could continue until the conversation is ultimately deemed salvaged or unsalvageable.

Error Handling when Prompting an LLM

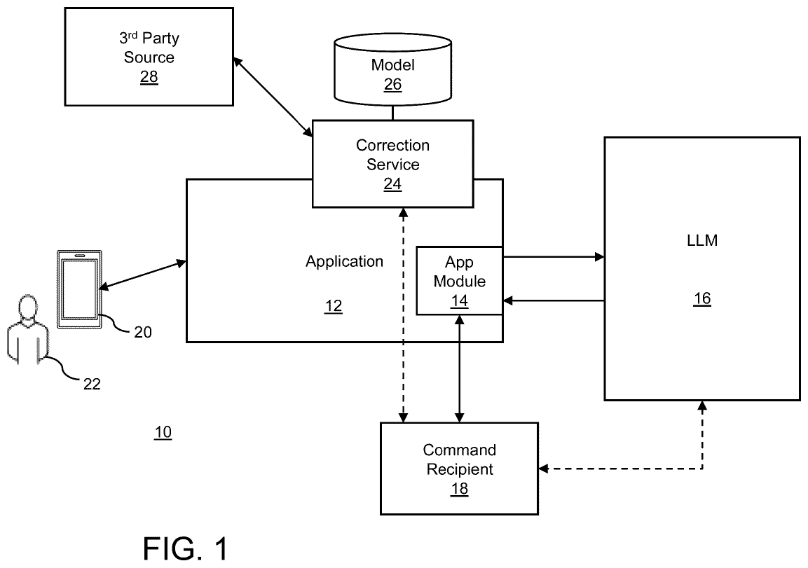

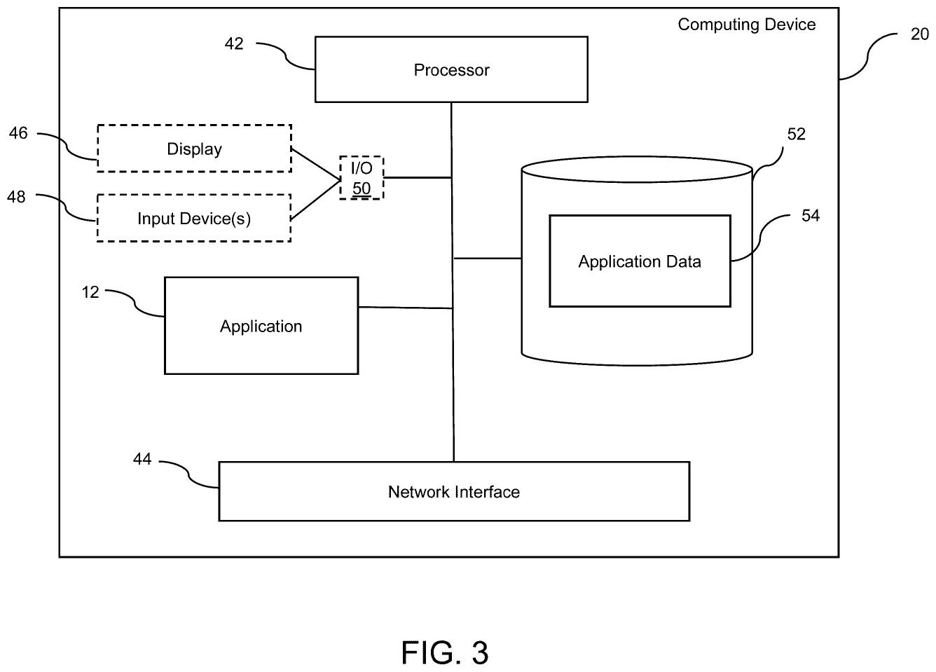

Referring now to the figures, FIG. 1 illustrates an example of a computing environment 10 in which an application 12 is provided by or in communication with one or more computing devices 20 or computing systems (see also FIG. 3). As illustrated in FIG. 1, the application 12 may be running on the computing device 20 (e.g., on a smartphone or tablet) or the computing device 20 may be in communication with the application 12 as it is hosted by/on a different computing device 20, e.g., a server device or other computer or computer system.

Such computing devices 20 (or computing systems) may include, but are not limited to, a mobile phone, a personal computer, a laptop computer, a server computer, a tablet computer, a notebook computer, a hand-held computer, a personal digital assistant, a portable navigation device, a wearable device, a gaming device, an embedded device, a virtual reality device, an augmented reality device, etc.

The application 12 includes an application (app) module 14 that may be a widget, tool, plug-in, function, script, or other computer program that is embodied as a stand-alone routine or may be integrated with the application 12 to execute an exchange of data and/or information with an LLM 16. In this example, the application 12 uses the LLM 16 to assist with or otherwise supplement information or instructions associated with an exchange with a user 22 (or other entity) to obtain information from or using the LLM 16. For example, the user 22 may engage in a chat session with a chatbot, with the chatbot being embodied by the application 12 and/or app module 14 to interact with the user 22. In such an example, the app module 14 may receive text or other multimedia messages from the user 22 and interact with the LLM 16 to obtain information such as a command to assist in responding to the message. In another example, the appl module 14 may be used by the application 12 to respond to an input to the application 12 by the user 22, wherein the input is something other than a conversational exchange, e.g., a query or other submission to the application 12 by the user 22.

As noted above, the application 12 may be hosted or otherwise run on the computing device 20 or may be accessed by the computing device 20 over a communication network (not shown). Such communication network(s) may include a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The application 12 may take the form of a mobile-type application (also referred to as an “app”—as illustrated), a desktop-type application, an embedded application in customized computing systems, or an instance or page contained and provided within a web/Internet browser, to name a few.

The LLM 16 may be provided by a separate computing device 20 or computing system, by a separate entity or may be integrated with the application 12 within the same computing device 20 or computing system. As such, the configuration shown in FIG. 1 is illustrative and other computing device/system configurations are possible. For example, the computing environment 10 shown in FIG. 1 may represent a single device such as a portable electronic device or the integration/cooperation of multiple electronic devices such as a client device and server device or a client device and a remote or offsite storage or processing entity or service. That is, the computing environment 10 may be implemented using any one or more electronic devices including standalone devices and those connected to offsite storage and processing operations (e.g., via cloud-based computing storage and processing facilities).

The app module 14 in this example is additionally in communication with a command recipient 18. The command recipient 18 may represent an entity that processes a command for the app module 14. The command may be something sought by the user 22 (or its computing device 20) in a request such as a chat message or query. For example, the user 22 may utilize a chat bot to request information to perform an action. This action may require a command for the command recipient 18. The command may be determined by prompting the LLM 16 in a first prompt, using the text from the chat message. In such an example, the command may be determined in a response obtained from the LLM 16, which is then provided to the command recipient 18 on behalf of the user 22 making the request to the chatbot. The command recipient 18 may generate an output, which may or may not be correct. Or may generate an error due to the command or the command's syntax being incorrect. In either scenario, the app module 14 may determine that the command or other output generated by the LLM 16 is erroneous.

The determination that the command is erroneous may, additionally or alternatively, be determined using a correction service 24. The correction service 24 may, therefore, perform error detection as well as obtain corrective information. As such, it can be appreciated that the determination of an error associated with the command or other output generated by the LLM 16 in response to a prompt by the app module may be made in various ways. In this way, the app module 14 may utilize the LLM 16 for and on behalf of the application 12 and the user 22/device 20 interacting with the application 12 to perform various tasks for which erroneous LLM outputs should be avoided. The app module 14 may be integrated in the application 12 as shown in FIG. 1 or may be a separate entity that is accessed to interact with the LLM 16. Moreover, it may be appreciated that the app module 14 may interact with multiple different LLMs 16 and only one LLM 16 is shown in FIG. 1 for illustrative purposes. Additionally or alternatively, the LLM 16 may be capable of, and instructed to, communicate with the command recipient 18 directly, e.g., to fetch information from a source based on the text it received when prompted.

The correction service 24 shown in FIG. 1 may be integrated with or otherwise be coupled to or in communication with the application 12. The correction service 24 is used by the app module 14 and application 12 to determine corrective information to perform error handling when interacting with the LLM 16. The correction service 24 may utilize one or more 3^{rd} party sources 28. The correction service 24 may, additionally or alternatively, utilize a model 26 which is different and separate from the LLM 16 being utilized by the app module 14. The model 26 may be considered a “side model” or supplemental or specialized model 26 that is used for determining and obtaining corrective information with respect to commands and other information obtained by prompting the “main” LLM 16 which generates errors. The model 26 may itself be, or may comprise, a generative model such as an LLM. The model 26 may, additionally or alternatively, utilize or access other models such as third party LLMs (not shown). The 3^{rd} party source 28 may include any source of information, such as a search engine, databank, database, catalogue, library, enterprise service, publicly available service, subscription service, etc. The 3^{rd} party source 28 may therefore include any entity that is capable of providing information that may be deemed to be corrective in nature in that the information may be utilized to generate corrective information such as corrective advice for remedying an error or otherwise having a subsequent prompt to the LLM 16 generate an accurate, or more accurate response.

The correction service 24 may interact with the application 12 and app module 14 and be instructed thereby. Additionally or alternatively, as illustrated using a dashed line, the correction service 24 may interact directly with the command recipient 18 to assist in determining whether an output from the LLM 16 is erroneous. Similarly, the correction service 24 may interact with the command recipient 18 to receive or obtain an error message or other information associated with an error whether that error is detected by the app module 14 or the correction service 24. As such, the correction service 24 may be utilized for more than determining corrective information. Moreover, it can be appreciated that an error associated with a response to a prompt provided to an LLM 16 may be detected in various ways using the application 12, app module 14, command recipient 18, and/or correction service 24 according to the nature of the prompt, the structure and contents of the response, and the manner in which the application 12 interacts with the LLM 16 and the user 22/device 20.

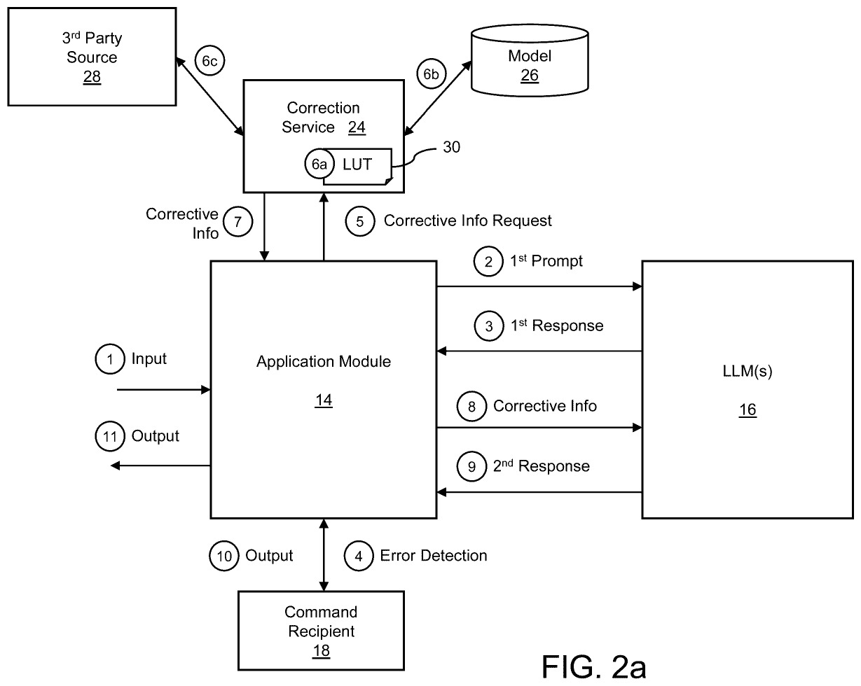

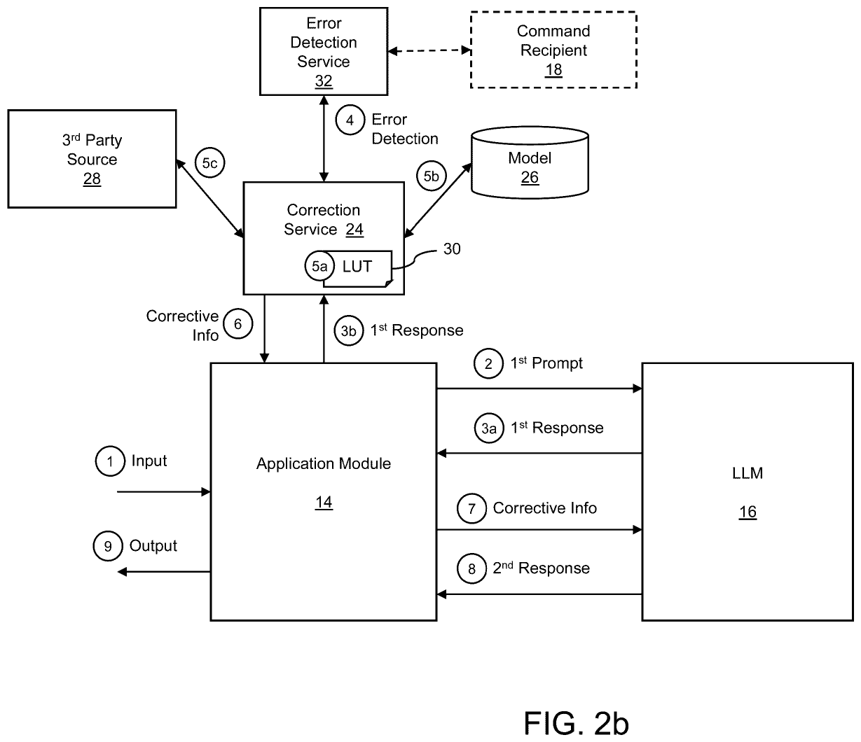

Referring now to FIG. 2a, one example of operations that may be performed in detecting and handling an error associated with an LLM prompt is shown. In this example, it is assumed that the app module 14 interfaces with the correction service 24, the command recipient 18, and the LLM 16. It can be appreciated that the delineation between the app module 14, correction service 24, and command recipient 18 is made for illustrative purposes and any of the shown capabilities may be performed by any one or more of the entities shown in this or other configurations.

At operation 1, an input is received by the app module 14. The input may be provided by the application 12. The application 12 may provide such an input on behalf of a user 22 and/or the user's computing device 20, e.g., in response to an input provided by such user 22 or by the computing device 20. For example, the app module 14 may be utilized by the application 12 to provide a chatbot function that is accessed by the user 22 when using the application 12 via the computing device 20. The chatbot function may be used to respond to a textual or other media input, which utilizes the LLM 16 to determine a command or other information that is used to perform an action or otherwise generate a response for which accuracy is deemed to be important. For example, the LLM 16 may be used to determine a command to be provided to the command recipient 18 to obtain an output to be passed back to the user. If the command generated by the LLM 16 is erroneous or generates an error message, the output should not be passed back to the user.

Responsive to the input, at operation 2, a 1^{st} prompt is provided to the LLM 16 to obtain a command that is associated with information in the input provided at operation 1. Responsive to the 1^{st} prompt, the LLM 16, at operation 3, the LLM 16 generates a 1^{st} response.

At operation 4, error detection occurs. Such error detection may be performed in various ways. For example, an error may be detected from the 1^{st} response itself. In this example, however, the error detection is determined by interacting with the command recipient 18 to “try out” the 1^{st} response. It is assumed in the example shown that the command suggested by the LLM 16 is incorrect or includes an error. This may include submitting the command and receiving an error message or detecting an error from something in the response from the command recipient 18. Error detection at operation 4 may be performed by the app module 14 in connection with the command recipient 18 or, additionally or alternatively, may rely on some other source, such as the correction service 24 as shown in a further example described below.

Errors may be caused by the command being incorrect or due to incorrect syntax. For example, the text from a chatbot message may request a command using one programming language, while the LLM 16 has been trained based on a different programming language and thus cannot recognize the syntax used.

At operation 5, responsive to detecting an error associated with the 1^{st} response from the LLM 16, the app module 14 may interface with the correction service 24 to make a corrective information request. The corrective information request may include any one or more of the original input, the 1^{st} prompt, the 1^{st} response, the command provided to the command recipient 18, a response from the command recipient 18, an error message (which may be included in such response from the command recipient), or other flags, tags, indicators or information determined by the app module 14. That is, the corrective information request may include any available information that the corrective service 24 is capable of receiving and parsing, e.g., from the app module 14.

Responsive to the corrective information request, the correction service 24 may perform a corrective information lookup. In this example, three example look up operations are shown, namely as operations 6a, 6b, and 6c. It can be appreciated that any one or more of operations 6a, 6b, and 6c may be performed depending on the nature of the error, the amount of information provided in the corrective information request, and what sources, utilities and tools are available to the correction service 24.

In this example, operation 6a includes accessing a look-up table (LUT) 30. The LUT 30 may include any table, spreadsheet, database, or other data structure that may hold information relevant to error handling or outcomes or parameters associated with the commands being requested in response to the input at operation 1. For example, the LUT 30 may include multiple tables, each table being associated with a type of command and past errors that have been detected and corrected. The LUT 30 may be built and expanded over time, e.g., as new errors are resolved by the app module 14. The LUT 30 may, additionally or alternatively, be provided by a third party. For example, the LUT 30 may include a help manual, catalogue or compendium of diagnostic or error handling text, videos or other multimedia.

Operation 6b, in this example, includes utilizing the model 26. This may include providing an input to a machine learning module that utilizes the input and the model to determine suitable corrective advice. The model 26 may be created and trained by the correction service 24 or may be an off-the-shelf model 26. Multiple models 26 may be utilized depending on the application 12, the expected inputs at operation 1, the type of command, etc. The model 26 may be a generative model such as another LLM. The other LLM may be considered a side model or side LLM that is used for error handling and corrective information to avoid the need to retrain or update the main LLM 16, which may be computationally expensive and time consuming, among other things. The side model 26 (e.g., side LLM) may be agile and relatively smaller in size than the main LLM 16, making refinements and ongoing training quicker and more efficient. Moreover, as noted above, multiple models 26 may be employed by the correction service 24, each model 26 being trained and tailored to different types of applications 12, inputs, commands, etc.

Operation 6c, in this example, includes one or more queries or requests made to one or more 3^{rd} party sources 28. The 3^{rd} party sources 28 may include any information source that is capable of being accessed by the correction service 24. This may include a public source such as a search engine, a private source such as an enterprise catalogue or database or a subscription-based service that is publicly available by requiring some form of credential. It can be appreciated that the 3^{rd} party source(s) 28 may be used interactively to request and receive information, or may be used to offload an analysis or inquiry based on the corrective information request at operation 5. For example, a 3^{rd} party source 28 may itself have access to models (including LLMs 16), services, personnel, bots, etc., which may be leveraged by the correction service 24 to perform error handling for the app module 14 and application 12.

Determining the corrective information may include parsing a first syntax associated with the input or the 1^{st} prompt. A syntax translation schema may be used to determine the corrective information by converting the first syntax to a second syntax.

The correction service 24 may include a logging function or service (not shown in FIG. 2a) to track, record, and store information exchanged by the correction service 24 and any entity with which it interacts. For example, the correction service 24 may include logs of responses generated by a model 26 to provide additional training sets for refining the model 26 over time. Similarly, the LUT 30 may be updated using logs generated during interactions with the 3^{rd} party sources 28 and/or model 26 to improve the LUT 30 as the correction service 24 is utilized. In this way, the LUT 30 may be used as a first step in determining corrective information, prior to seeking out further information from a 3^{rd} party source 28 and/or by utilizing a model 26.

The correction service 24 may therefore generate suitable corrective information using any available service, database or utility such that, at operation 7, the corrective information may be returned to the app module 14.

Responsive to receiving the corrective information, at operation 8, the corrective information may form the basis of a 2^{nd} prompt or addendum to the 1^{st} prompt by interacting again with an LLM 16. This may include re-prompting the same LLM 16, a different LLM 16, a newer version of a previously used LLM 16, etc. The corrective information may, optionally, be provided at operation 8 along with other data or information. For example, the corrective information may be provided with any one or more of the original input, the 1^{st} prompt, the 1^{st} response, a command provided to the command recipient, an error message received from the command recipient, error information detected by the app module 14 and/or correction service 24 (or elsewhere as described below in connection with FIG. 2b), etc. That is, the corrective information may form the basis for a subsequent attempt to prompt an LLM 16 to provide an appropriate (e.g., correct) response to the input received at operation 1.

The LLM 16 provides a 2^{nd} response at operation 9, which is responsive to the 2^{nd} prompt that includes the corrective information at operation 8. In this example, it is assumed that the 2^{nd} response at operation 9 provides a command that may be output at operation 10 to the command recipient 18, thus generating the correct output at operation 11 to be returned to the originator of the input at operation 1, for example, a correspondent in a conversation with a chatbot. For example, the output at operation 11 may be a correct hyperlink to a site or service requested in the input at operation 1, a set of requested information (e.g., all customers that ordered 3 of these items in the past 6 months). In another example, the output at operation 11 may include a correct module or other snippet of computer code requested by a developer. That is, the term “command” as used in this example may include any element of data, information, instructions, code, etc. that, when acted upon by the requestor (e.g., correspondent in a conversation with a chatbot) may result in a correct or incorrect (erroneous) outcome.

It can be appreciated that if the output at operation 10 generates a further error, the process may repeat from operations 4/5, as described above. This may repeat for as many times as desired (or permitted) until the interaction (e.g., conversation) is deemed to be salvageable or unsalvageable. By determining corrective information, it is expected that more exchanges may result in correct responses and thus be salvaged than would otherwise occur based on errors and error messages only.

Referring now to FIG. 2b, another example of operations that may be performed in detecting and handling an error associated with an LLM prompt is shown. In this example, the application module 14 relies on the correction service 24 to perform error detection, or has the correction service 24 otherwise coordinate or request another service to perform such error detection. That is, the app module 14 does not communicate directly with the command recipient 18 in this example. The configuration shown in FIG. 2b may represent an example in which the information obtained from the LLM 16 is evaluated to determine potential errors without necessarily trying a command to determine if an error or error message is triggered. However, as shown in dashed lines in FIG. 2b, the command recipient 18 may be communicated with if necessary to determine same.

As with the earlier example, at operation 1, an input is received by the app module 14. The input may be provided by the application 12. The application 12 may provide such an input on behalf of a user 22 and/or the user's computing device 20, e.g., in response to an input provided by such user 22 or computing device 20. For example, the app module 14 may be utilized by the application 12 to provide a chatbot function that is accessed by the user 22 when using the application 12. The chatbot function may be used to respond to textual or other media input, which utilizes the LLM 16 to determine a command or other information that is used to perform an action or otherwise generate response for which accuracy is deemed to be important, as described above.

Responsive to the input, at operation 2, a 1^{st} prompt is provided to the LLM 16 to obtain a command that is associated with information in the input provided at operation 1. Responsive to the 1^{st} prompt, the LLM 16, at operation 3a, the LLM 16 generates a 1^{st} response.

In this example scenario, the 1^{st} response may be provided by the app module 14 to the correction service 24 at operation 3b. In this way, the correction service 24 can perform or coordinate error detection at operation 4. In the configuration shown in FIG. 2b, error detection may be performed by providing the 1^{st} response to an error detection service 32. The error detection service 32 may be used to analyze the content of the 1^{st} response and any context available to detect whether that content would generate an error. As with the earlier example, the error detection service 32 may try an associated command by communicating with the command recipient 18, e.g., to determine if an error message is triggered. The error detection service 32 may itself be programmed to identify errors or access other services to determine that such an error is likely to occur, e.g., an output parser.

In this scenario, the correction service 24 is aware of the error by communicating with the error detection service 32 and, thus, triggers a corrective information lookup. In this example, three example lookup operations are shown, namely as operations 5a, 5b, and 5c. It can be appreciated that any one or more of operations 5a, 5b, and 5c may be performed depending on the nature of the error, the amount of information provided in the corrective information request, and what sources, utilities and tools are available to the correction service 24.

In this example, operation 5a includes accessing the LUT 30, which may be similar to that shown in FIG. 2a. Operation 5b, in this example, includes utilizing the model 26, also similar to that described above. Operation 5c, in this example, includes one or more queries or requests made to one or more 3^{rd} party sources 28.

The correction service 24 may therefore generate suitable corrective information using any available service, database or utility such that, at operation 6, the corrective information may be returned to the app module 14.

Responsive to receiving the corrective information, at operation 7, the corrective information may form the basis of a 2^{nd} prompt or addendum to the 1^{st} prompt by interacting again with an LLM 16. This may include re-prompting the same LLM 16, a different LLM 16, a newer version of a previously used LLM 16, etc. The corrective information may, optionally, be provided at operation 7 along with other data or information. For example, the corrective information may be provided with any one or more of the original input, the 1^{st} prompt, the 1^{st} response, a command provided to the command recipient, an error message received from the command recipient, error information detected by the app module 14 and/or correction service 24, etc. That is, the corrective information may form the basis for a subsequent attempt to prompt an LLM 16 to provide an appropriate (e.g., correct) response to the input received at operation 1.

The LLM 16 provides a 2^{nd} response at operation 8, which is responsive to the 2^{nd} prompt that includes the corrective information at operation 7. In this example, it is assumed that the 2^{nd} response at operation 8 provides the correct output at operation 9 to be returned to the originator of the input at operation 1, for example, a correspondent in a conversation with a chatbot. It can be appreciated from FIG. 2b that the responsibilities in error detection may be assumed by any one of the app module 14, the correction service 24 and/or another entity altogether such as the error detection service 32 and/or command recipient 18 in various configurations.

It can also be appreciated that the actions performed by the error detection service 32 may be performed by the application module 14 or the correction service 24 and a separate service is shown for illustrative purposes. For example, the error detection service 32 may be provided by a separate entity such as an entity that is or utilizes an output parser. Additionally or alternatively, the error detection service 32 may be used to determine if an error can be detected and, if not, resort to providing the command to a service that can process the command, such as the command recipient 18 as shown in dashed lines.

FIG. 3 shows an example of a computing device 20 which may be utilized by any one or more of the entities shown in FIG. 1, for example, a personal electronic device or server used to provide the application 12 or other computing device 20 used to communicate with the LLM 16 via the application 12. The computing device 20 in FIG. 3 may, additionally or alternatively, provide an example of a device on which the LLM 16 may be deployed or accessed.

In this example, the computing device 20 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 20 may also include the application 12 (or other application(s)), a data store 52, and client application data 54.

The data store 52 may represent a database or library or other computer-readable medium configured to store data and permit retrieval of data by the computing device 20. The data store 52 may be read-only or may permit modifications to the data. The data store 52 may also store both read-only and write accessible data in the same memory allocation. In this example, the data store 52 stores the application data 54 for the application 12 (and/or app module 14) that is configured to be executed by the computing device 20 for a particular role or purpose.

While not delineated in FIG. 3, the computing device 20 includes at least one memory or memory device that can include a tangible and non-transitory computer-readable medium having stored therein computer programs, sets of instructions, code, or data to be executed by processor(s) 42. The processor(s) 42 and network interface(s) 44 are connected to each other via a data bus or other communication backbone to enable components of the computing device 20 to operate together as described herein. FIG. 3 illustrates examples of modules and applications stored in memory on the computing device 20 and executed by the processor(s) 42.

It can be appreciated that any of the modules and applications shown in FIG. 3 may be hosted externally and may be available to the computing device 20, e.g., via a network interface 44. The data store 52 in this example stores, among other things, the application data 54 that can be accessed and utilized by the application 12 and/or app module 14. The data store 52 may additionally store one or more software functions or routines in a cache or in other types of memory (e.g., the app module 14 may be stored in the data store 52 separately from the application 12).

As shown in FIG. 3, the computing device 20 may, optionally (e.g., when configured as a personal electronic device such as a smartphone or tablet), include a display 46 and one or more input device(s) 48 that may be utilized via an input/output (I/O) module 50. That is, such components may be omitted when the computing device 20 does not interact with a user.

While examples referred to herein may refer to a single display 46 for ease of illustration, the principles discussed herein may also be applied to multiple displays 46, e.g., to view portions of UIs rendered by or with the application 12 on separate side-by-side screens. That is, any reference to a display 46 may include any one or more displays 46 or screens providing similar visual functions. The application 12 receives one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user 22 interacting with the computing environment 10, e.g., by operating the computing device 20 as illustrated in FIG. 1.

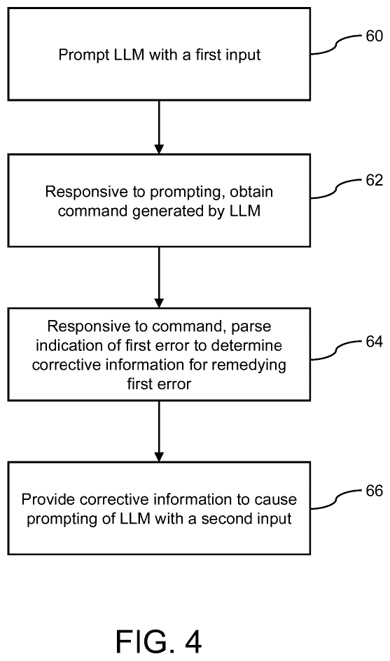

Referring now to FIG. 4, a flow chart is provided illustrating example operations for error handling in prompting an LLM. The operations shown in FIG. 4 may be implemented by an electronic device (e.g., computing device 20 shown in FIGS. 1 and 3), a server, or other computing system, computing service, or other computing entity in the computing environment 10.

At block 60, the application 12, e.g., using the app module 14 as illustrated above, prompts an LLM 16 with a first input, i.e., the 1^{st} prompt shown in FIGS. 2a and 2b. The 1^{st} prompt or first input to the LLM 16 may include text or other data provided in an input to the application 12, e.g., text extracted from a message in a conversation with a chatbot.

At block 62, responsive to the 1^{st} prompt, the app module 14 obtains a command generated by the LLM 16. For example, the LLM 16 may determine a command or other information based on what is requested in the text of the conversation message.

Responsive to execution of or parsing of the command, at block 64, an indication of a first error is parsed, to determine corrective information for remedying the first error. As illustrated in FIGS. 2a and 2b, the first error may be detected by trying the command with a command receipt 18, by using an error detection service 32 or using any other routine or set of steps that is capable to determining that the command returned by the LLM 16 is erroneous or otherwise is not what was requested in an input provided to the application 12. The corrective information may be generated by the correction service 24, e.g., by utilizing the LUT 30, model 26, 3^{rd} party source(s) 28, etc. as discussed earlier.

At block 66, the corrective information is provided, e.g., by the correction service 24 to the app module 14, to cause prompting of an LLM 16, e.g., the same LLM 16 used in block 60 or another LLM 16, with a second input, e.g., the 2^{nd} prompt shown in FIGS. 2a and 2b.

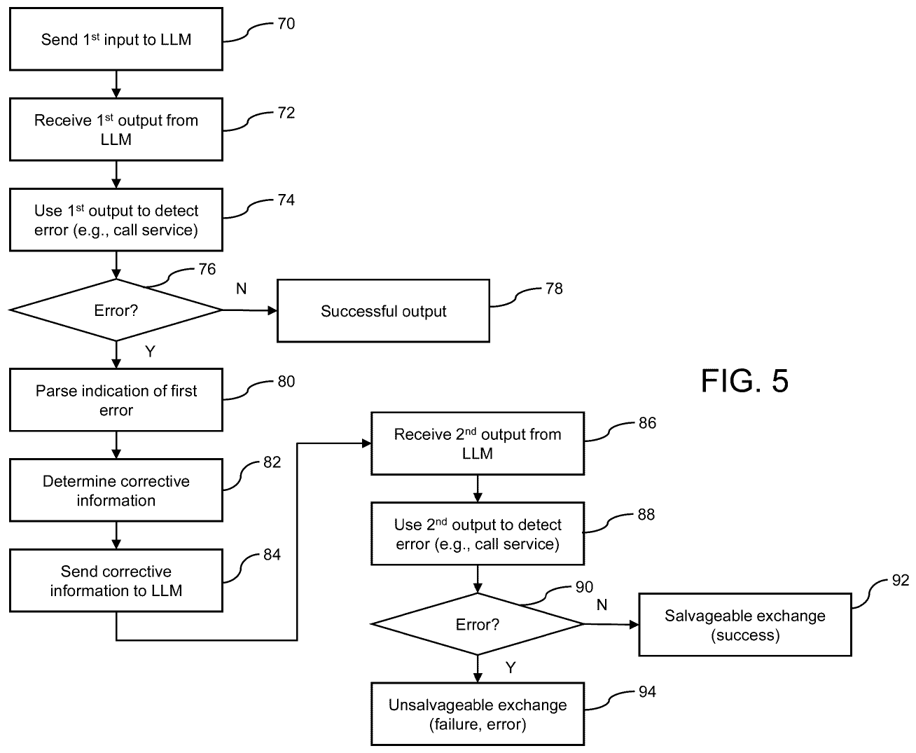

Referring now to FIG. 5, a flow chart is provided illustrating example operations for prompting an LLM 16 to remedy an error to salvage an exchange with an entity that utilizes the LLM 16. The operations shown in FIG. 5 may be performed by the application 12, app module 14 or other entity that is configured to utilize an LLM 16 in the way illustrated above.

At block 70, a first input is sent to the LLM 16 and at block 72, a first output or first response to the first input is received. The first output is used at block 74 to detect an error. For example, this may include trying a command or inputting information returned by the LLM 16 to a service such as the command recipient 18 or by utilizing an error detection service 32 and/or the correction service 24. At block 76, it is determined whether the first output returned by the LLM 16 includes an error, e.g., based on an error message, syntax error, or by parsing the contents of the output to determine that it includes erroneous information or is otherwise not what is expected or desired based on the originating input.

Responsive to no error being detected, a successful output may be returned at block 78. Responsive to detecting an error, an indication of a first error may be parsed at block 80. The parsing at block 80 may include determining the nature of the error and/or providing the indication of the error to the correction service 24 to determine corrective information at block 82. The corrective information may be determined and obtained using various techniques and sources, such as those illustrated in FIGS. 1, 2a and 2b. At block 84, the corrective information may be sent to the LLM 16 (or a different LLM 16) as a second prompt or second input. As discussed above, the second input may include additional information, such as the original input, the original output, the error or error message contents, etc.

At block 86, a second output or response is received from the LLM 16 utilized in the second prompt that includes the corrective information. The second output may be used at block 88 to detect an error, similar to block 74. For example, the LLM 16 may return a different command that may be tried using the command recipient 18 to determine if the command generates the expected response.

At block 90, it is determined whether the second output returned by the LLM 16 includes an error, e.g., based on an error message, syntax error, or by parsing the contents of the output to determine that it includes erroneous information or is otherwise not what is expected or desired based on the originating input.

Responsive to no error being detected, a successful output may be returned at block 92 and in this case represents a salvageable exchange. Responsive to detecting an error at block 90, an indication of a second error may be parsed at block 94. As illustrated in FIG. 5, parsing the second error may result in a failure or error message, representing an unsalvageable exchange. However, the process may be repeated one or more additional times, e.g., until the exchange is salvaged or until a timeout or other criterion is met suggesting that the exchange cannot be salvaged.

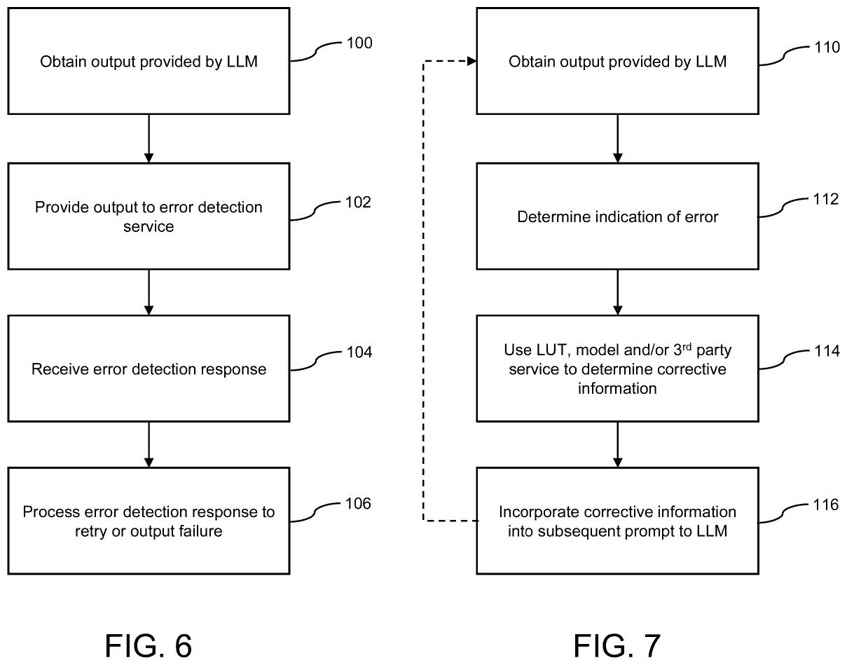

In FIG. 6, a flow chart is provided illustrating example operations for utilizing an error detection service 32 to detect an error in a response from an LLM. At block 100, an output provided by an LLM 16 in response to a prompt is obtained. The output is provided to the error detection service 32 at block 102. The error detection service 32 may utilize a set of metrics or rules, call an external service, execute operations according to certain logic, or perform analyses, including utilizing machine learning or another, different LLM to generate the output. The output may include an indication of whether or not the output from the LLM 16 is erroneous or is otherwise not what has been requested and/or is not what is expected.

At block 104, the application 12, app module 14, or correction service 24 receives the error detection response and, at block 106, processes the error detection response to retry the LLM prompting exchange or to output a failure. For example, at block 106, the app module 14 may determine from the error detection response that corrective information may be determined to obtain a correct response from the LLM 16.

In FIG. 7, a flow chart is provided illustrating example operations for determining corrective information for a subsequent prompt to an LLM 16. At block 110 an output provided by the LLM 16 is obtained and, at block 112, an indication of an error (e.g., error message) is obtained. For example, as illustrated above, the app module 14 may try a command returned by the LLM 16 with the command recipient 18 or some other external service, e.g., the error detection service 32. At block 114, corrective information may be determined, e.g., using the correction service 24, using the LUT 30, model 26, and/or 3^{rd} party service(s) 28. The corrective information may be incorporated into a subsequent prompt to the LLM 16 or a different LLM 16 at block 116. As shown in dashed lines, this process may repeated one or more additional times, e.g., until the exchange is deemed salvageable or not.

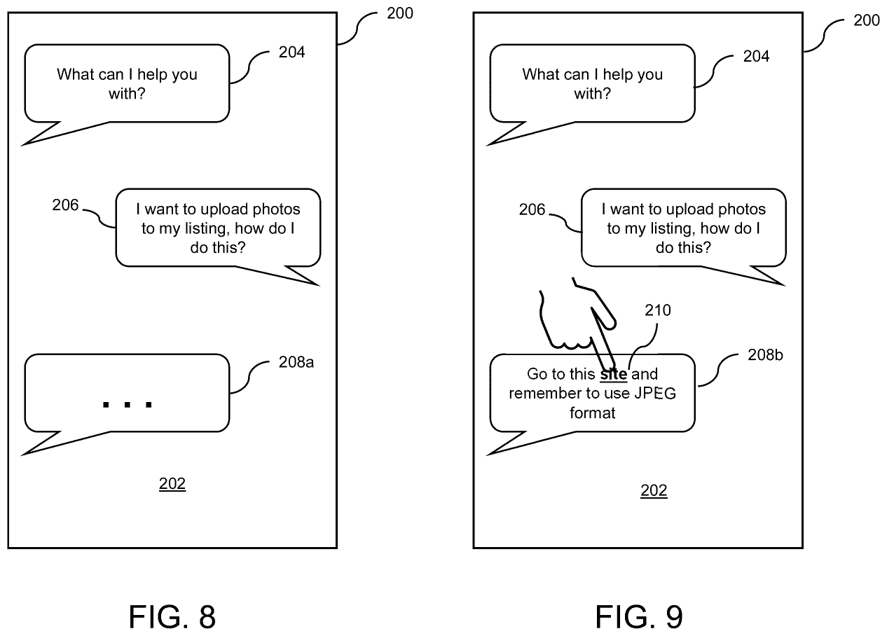

Referring now to FIG. 8, a message exchange user interface UI 200 is shown, e.g., for conducting a conversation with a chatbot that utilizes an LLM 16 to assist with queries, questions, or other requests. The UI 200 includes a messaging page 202 that includes messages exchanged between parties. In this example, a first message 204 includes a question provided by a chatbot to illicit a conversation, namely: “What can I help you with?”. In response, a second message 206 is composed and sent by a correspondent, e.g., the user 22. In this example, the correspondent poses a question in response to the offer for help in the first message 204, namely: “I want to upload photos to my listing, how do I do this?”. Here, the correspondent is using the chatbot to determine how to do something, which may include a command, such as a link to an appropriate tool or site. The chatbot creates a pending message 208a with a series of dots to signify that it is obtaining an answer at which time, the process such as that shown in FIG. 4 or 5 may be performed by an app module 14 or application 16 that is providing the chatbot.

As shown in FIG. 9, the pending message 208a may be transformed or converted into a responsive message 208b, which includes a link 210 to a site that enables the user 22 to upload their photos. The message 208b may also include additional instructional information as shown. The link 210, when selected, may open a web browser with a page associated with the link, may open an app and appropriate tool, or may execute automated instructions to being the uploading process. It can be appreciated that the responsive message 208b may include any information or command that is deemed to correct, that is, is found to not be erroneous to avoid errors being returned to the user 22. If the link 210 could not be found or is deemed to be erroneous, an error message may be provided indicating that the request could not be fulfilled or requesting different information if the correction service 24 could not determine same.

A message exchange or conversation such as that shown in FIGS. 8 and 9 may be utilized in many other applications and use cases. For example, a chatbot may be used by a programmer or developer to determine modules, commands or other data structures. Similarly, the chatbot may be used by an operator of a utility or service that needs to respond to events and queries the chatbot to determine a command, function, service or set of instructions that should be executed in response to that event. That is, the LLM 16 may be leveraged via a chatbot and the correction service 24 used for error handling to inhibit erroneous responses from being returned to the user 22.

One example may include a merchant that uses the chatbot for obtaining information from an e-commerce platform. The chatbot in this example may leverage the LLM 16 to query the platform for particular data. In this example, the original query may include: “how many customers have purchased my product between 3 and 10 times in the past year”.

The LLM 16 may generate a syntax error in formulating a search string or command for the platform. For example, the LLM 16 may have used “count_at_least” as a parameter for the function “products_purchased”. In this case a syntax error occurs, where the correction service 24 identifies an incorrect segmentation query and has a second LLM query executed.

For example, based on an analysis of the parameters and/or one or more additional with a command recipient 18 or the LLM 16 itself, it may be determined that “quantity_at_least” and “quantity_at_most” generated in the first attempt refer to the quantity of products purchased per order, not the number of orders. Instead, the filter “number_of_orders” associated with a particular product identifier is correct. The correction service 24 and/or the error detection service 32 may be utilized to detect this syntax error and have the LLM 16 return the “number_of_orders” based on corrective information that indicates that the “quantity_at_least” and “quantity_at_most” incorrectly refer to products purchased per order rather than the total number of orders. That is, the corrective information may indicate that the parameters should be associated with the number of orders that include the merchant's product and not quantities of type within a given order.

Another example of a chatbot application is provided below. In this example, the correction service 24 is utilized alongside a chatbot or virtual assistant service. The chatbot or assistant service may exist as a text conversation where a user 22 may input text in a message, with response text output to the user's screen in response to the input text.

In addition to the text response, the chatbot or assistant service may perform actions such as navigating to a webpage, displaying screens, changing text on the screen (other than the chat conversation), filling out forms, writing to databases, etc. The chatbot or assistant service may use internal and/or external data sources to source information that it outputs in its response text or to perform other actions displayed to the user or performed in the background. The chatbot may utilize one or more generative models or LLMs 16, or other models to process the user input along with various types of prompts and other parameters. The generative model(s) or LLM(s) 16 or other model(s) may be fine-tuned or general purpose. The model(s) may make use of one or more adaptation layers (e.g., a Low Rank Adaptation Model or LoRA). The chatbot conversation may involve multiple rounds of user input, and chatbot response text forming a conversation. In some rounds of the conversation the only output is chatbot text. In some rounds of the conversation, additional output to the screen of webpages, navigation widgets, forms, pre-filled forms, action buttons, information screens, graphics, multimedia, etc. or output to a disk, memory, database, network connection, etc., may occur.

The corrective actions stemming from the corrective information determined by the correction service 24 may take various forms. In a first example, an initial LLM 16 generates a code block. The code may be run through validations, finding syntax errors. The correction service 24 may then issue corrective messages, e.g., “we found a syntax error on line 5, repair it and retry”. Next, the app module 14 may repair the conversation to delete the erroneous messages or to otherwise surface the repaired code in a subsequent message.

In another example, the LLM 16 may be found to generate mostly good results, but is missing some portion of the information, code, command, etc. The app module 14 may use the correction service 24 to send corrective messages to elicit the missing parts from the LLM 16. For example, the LLM 16 may have filled out title and description of an item but omitted price. In such cases, a corrective message may be issued asking the LLM 16 to include the price and the responses may be merged together to create the idealized first response that was desired from the LLM 16. The merged response may then be returned as the output instead of the incomplete response.

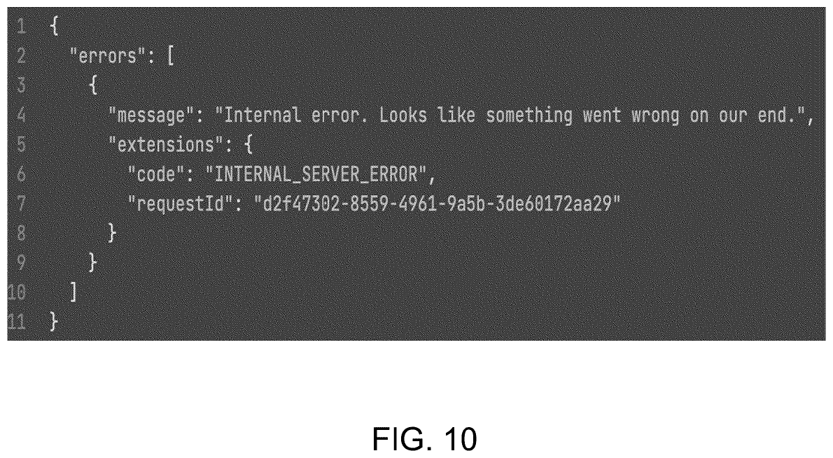

In another example, the initial LLM 16 used generates a GraphQL query to fetch data that is to be provided in an answer to a user's question to a chatbot. GraphQL servers typically have 3 types of errors: syntax errors, validation errors, and resolver errors. The response may also include information in an errors array of its response. The errors array may include a message and extensions as illustrated in FIG. 10.

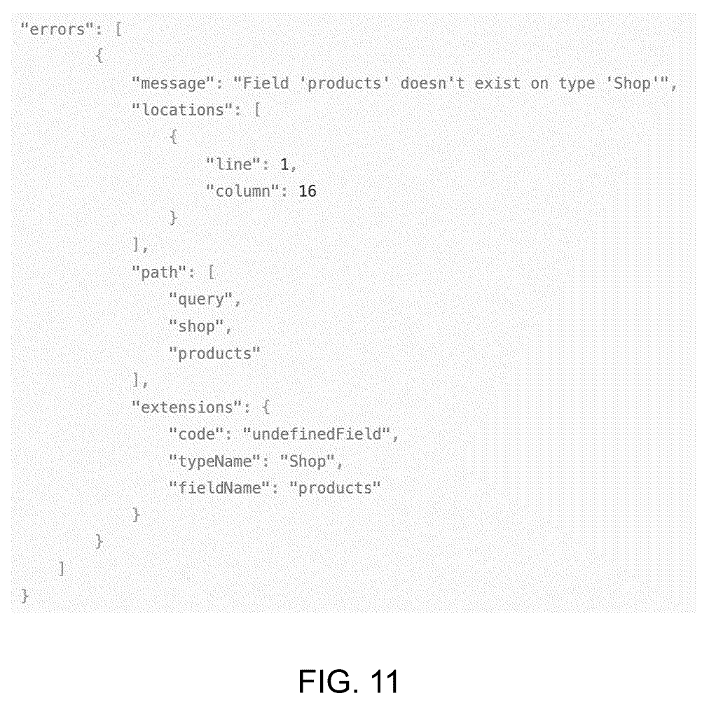

The error type and information in the errors array may be used to look up corrective information in a data store. In one example, the error message may be used to generate embeddings. The embeddings may be used to search a data store of corrective advice for semantically similar advice. The corrective information or advice may then be fed into the LLM 16 to regenerate the GraphQL Query. Example corrective advice for the error message shown in FIG. 11 could be: “The field ‘products’ doesn't exist on the type ‘Shop’. Only use the fields ‘location’, ‘name’ or ‘owner’.”

Examples of generative models that may be used include, for example, OpenAI's Generative Pre-trained Transformer family (GPT 3.5, GPT 4, ChatGPT), Meta's Llama and Llama 2, CohereAI's Command, Mistral/Mixtral, Anthropic's Claude, Google's Gemini, Gemma and Bard. These general purpose and chat-focused models may be used as both the first and second model. It can be appreciated that, in addition, more specialized models may be used as the first or second model. For example, if the error in the first model is related to code generation then a generative model specializing in code generation may be used as the second model—the Code Llama, HuggingFace's CodeGen, Github Copilot's Codex model or similar may be used. In some cases, instead of text generation models, multimodal or multimedia models may be used such as BLIP-2, CLIP, or GPT-4V. These may be used to analyze user interfaces or user interface elements, or generate user interfaces or user interface elements.

It can be appreciated that although transformer-based language models are described herein, the present disclosure may be applicable to any ML-based language model, including language models based on other neural network architectures such as recurrent neural network (RNN)-based language models. Indeed, the consideration of an LLM 16 above is by way of example and the present disclosure and principles are not necessarily so limited. For example, the techniques described above may be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM 16 in it, may be employed in association with the above-discussed techniques.

### Neural Networks and Machine Learning

To assist in understanding the present disclosure, some concepts relevant to neural networks and machine learning (ML) are discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), RNNs, and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

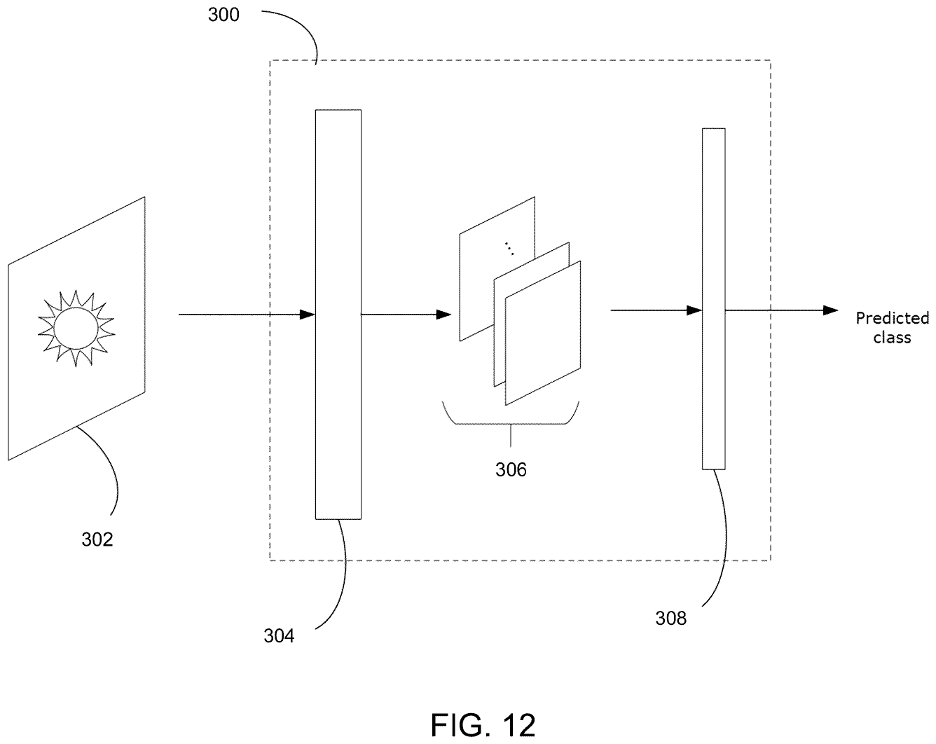

FIG. 12 is a simplified diagram of an example CNN 300, which is an example of a DNN that is commonly used for image processing tasks such as image classification, image analysis, object segmentation, etc. An input to the CNN 300 may be a 2D RGB image 302.

The CNN 300 includes a plurality of layers that process the image 302 in order to generate an output, such as a predicted classification or predicted label for the image 302. For simplicity, only a few layers of the CNN 300 are illustrated including at least one convolutional layer 304. The convolutional layer 304 performs convolution processing, which may involve computing a dot product between the input to the convolutional layer 304 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 304 is a set of feature maps 306 (sometimes referred to as activation maps). Each feature map 306 generally has smaller width and height than the image 302. The set of feature maps 306 encode image features that may be processed by subsequent layers of the CNN 300, depending on the design and intended task for the CNN 300. In this example, a fully connected layer 308 processes the set of feature maps 306 in order to perform a classification of the image, based on the features encoded in the set of feature maps 306. The fully connected layer 308 contains learned parameters that, when applied to the set of feature maps 306, outputs a set of probabilities representing the likelihood that the image 302 belongs to each of a defined set of possible classes. The class having the highest probability may then be outputted as the predicted classification for the image 302.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of an LLM may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

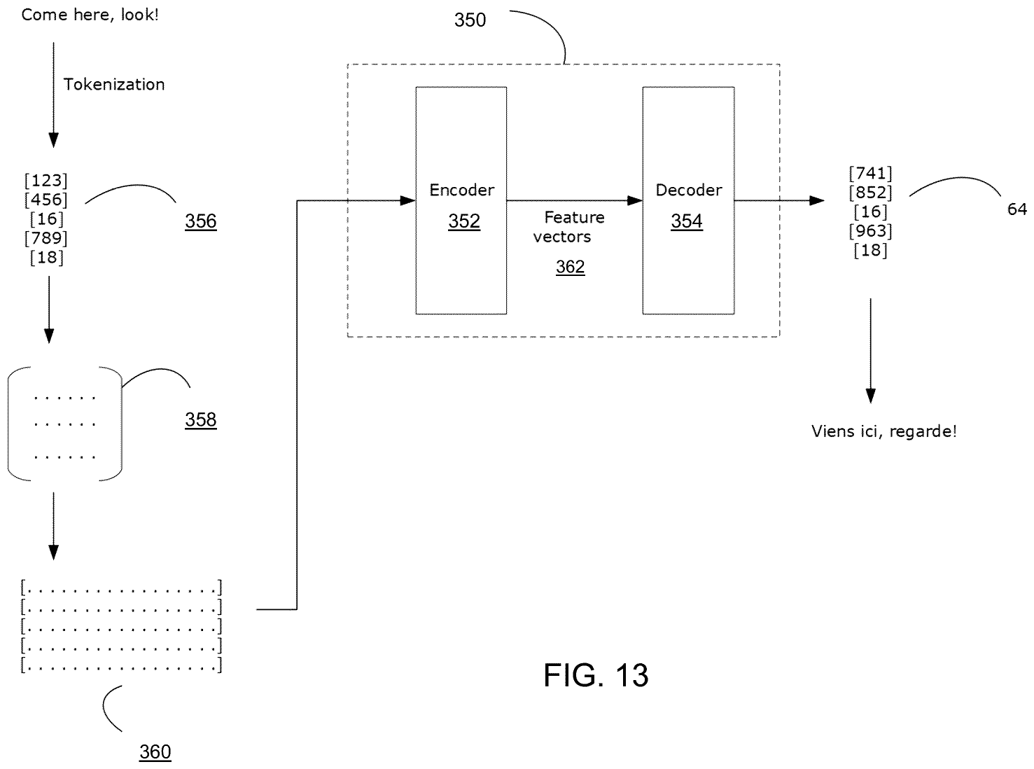

FIG. 13 is a simplified diagram of an example transformer 350, and a simplified discussion of its operation is now provided. The transformer 350 includes an encoder 352 (which may comprise one or more encoder layers/blocks connected in series) and a decoder 354 (which may comprise one or more decoder layers/blocks connected in series). Generally, the encoder 352 and the decoder 354 each include a plurality of neural network layers, at least one of which may be a self-attention layer. The parameters of the neural network layers may be referred to as the parameters of the language model.

The transformer 350 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 350 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 13, a short sequence of tokens 356 corresponding to the text sequence “Come here, look!” is illustrated as input to the transformer 350. Tokenization of the text sequence into the tokens 356 may be performed by some pre-processing tokenization module such as, for example, a byte pair encoding tokenizer (the “pre” referring to the tokenization occurring prior to the processing of the tokenized input by the LLM), which is not shown in FIG. 13 for simplicity. In general, the token sequence that is inputted to the transformer 350 may be of any length up to a maximum length defined based on the dimensions of the transformer 350 (e.g., such a limit may be 2048 tokens in some LLMs). Each token 356 in the token sequence is converted into an embedding vector 360 (also referred to simply as an embedding). An embedding 360 is a learned numerical representation (such as, for example, a vector) of a token that captures some semantic meaning of the text segment represented by the token 356. The embedding 360 represents the text segment corresponding to the token 356 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 360 corresponding to the “look” token will be closer to another embedding corresponding to the “see” token in the vector space, as compared to the distance between the embedding 360 corresponding to the “look” token and another embedding corresponding to the “cake” token. The vector space may be defined by the dimensions and values of the embedding vectors. Various techniques may be used to convert a token 356 to an embedding 360. For example, another trained ML model may be used to convert the token 356 into an embedding 360. In particular, another trained ML model may be used to convert the token 356 into an embedding 360 in a way that encodes additional information into the embedding 360 (e.g., a trained ML model may encode positional information about the position of the token 356 in the text sequence into the embedding 360). In some examples, the numerical value of the token 356 may be used to look up the corresponding embedding in an embedding matrix 358 (which may be learned during training of the transformer 350).

The generated embeddings 360 are input into the encoder 352. The encoder 352 serves to encode the embeddings 360 into feature vectors 362 that represent the latent features of the embeddings 360. The encoder 352 may encode positional information (i.e., information about the sequence of the input) in the feature vectors 362. The feature vectors 362 may have very high dimensionality (e.g., on the order of thousands or tens of thousands), with each element in a feature vector 362 corresponding to a respective feature. The numerical weight of each element in a feature vector 362 represents the importance of the corresponding feature. The space of all possible feature vectors 362 that can be generated by the encoder 352 may be referred to as the latent space or feature space.

Conceptually, the decoder 354 is designed to map the features represented by the feature vectors 362 into meaningful output, which may depend on the task that was assigned to the transformer 350. For example, if the transformer 350 is used for a translation task, the decoder 354 may map the feature vectors 362 into text output in a target language different from the language of the original tokens 356. Generally, in a generative language model, the decoder 354 serves to decode the feature vectors 362 into a sequence of tokens. The decoder 354 may generate output tokens 364 one by one. Each output token 364 may be fed back as input to the decoder 354 in order to generate the next output token 364. By feeding back the generated output and applying self-attention, the decoder 354 is able to generate a sequence of output tokens 364 that has sequential meaning (e.g., the resulting output text sequence is understandable as a sentence and obeys grammatical rules). The decoder 354 may generate output tokens 364 until a special [EOT] token (indicating the end of the text) is generated. The resulting sequence of output tokens 364 may then be converted to a text sequence in post-processing. For example, each output token 364 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs 16. An example GPT-type LLM 16 is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM 16, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an API). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM 16 may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM 16 may be referred to as a prompt, which is a natural language input that includes instructions to the LLM 16 to generate a desired output. A computing system may generate a prompt that is provided as input to the LLM 16 via its API. As described above, the prompt may optionally be processed or pre-processed into a token sequence prior to being provided as input to the LLM 16 via its API. A prompt can include one or more examples of the desired output, which provides the LLM 16 with additional information to enable the LLM 16 to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any entity within the computing environment 10 such as the computing device 20, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method, comprising:
parsing an indication of a first error to determine corrective information for remedying the first error, the first error responsive to a command generated by a large language model (LLM) responsive to prompting the LLM with a first input; and
providing the corrective information causing prompting of the LLM with a second input.

2. The method of claim 1, further comprising:
obtaining further input generated by the LLM responsive to the second input.

3. The method of claim 1, further comprising detecting the first error by calling a service to evaluate a first output from the LLM in response to the first input, the service identifying the indication of the first error.

4. The method of claim 1, wherein the second input further comprises at least one of the first input and an errant first output.

5. The method of claim 1, wherein the indication of the first error is provided in addition to the corrective information in causing the prompting of the LLM with the second input.

6. The method of claim 5, wherein the indication of the first error comprises an error message.

7. The method of claim 1, wherein parsing the indication of the first error to determine the corrective information comprises referencing a model.

8. The method of claim 7, wherein the model comprises a second LLM prompted by a correction service utilized to parse the indication of the first error.

9. The method of claim 1, wherein parsing the indication of the first error to determine the corrective information comprises accessing information provided by a third-party source.

10. The method of claim 9, wherein parsing the indication of the first error to determine the corrective information comprises conducting a search using one or more searching tools provided by the third-party source.

11. The method of claim 1, further comprising:
detecting a second error generated by the LLM in response to prompting the LLM with the second input; and
outputting at least one of the first error and the second error.

12. The method of claim 1, further comprising:
parsing an indication of a second error to determine additional corrective information for remedying at least one of the first error and the second error, the second error responsive to the corrected command generated by the LLM responsive to prompting the LLM with the second input; and
providing the additional corrective information causing prompting of the LLM with a third input.

13. The method of claim 12, further comprising:
obtaining further input generated by the LLM responsive to the third input.

14. The method of claim 12, wherein the indication of the second error is provided in addition to the corrective information in causing the prompting of the LLM with the third input.

15. A computer system comprising:
at least one processor; and
at least one memory, the at least one memory comprising processor executable instructions that, when executed by the at least one processor, cause the computer system to:
parse an indication of a first error to determine corrective information for remedying the first error, the first error responsive to a command generated by a large language model (LLM) responsive to prompting the LLM with a first input; and
provide the corrective information causing prompting of the LLM with a second input.

16. The computer system of claim 15, further comprising instructions that, when executed by the at least one processor, cause the computer system to:
obtain further input generated by the LLM responsive to the second input.

17. The computer system of claim 15, further comprising instructions that, when executed by the at least one processor, cause the computer system to detect the first error by calling a service to evaluate a first output from the LLM in response to the first input, the service identifying the indication of the first error.

18. The computer system of claim 15, wherein the second input further comprises at least one of the first input and an errant first output.

19. The computer system of claim 15, wherein the indication of the first error is provided in addition to the corrective information in causing the prompting of the LLM with the second input.

20. A computer-readable medium comprising processor executable instructions that, when executed by a processor of a computer system, cause the computer system to:
parse an indication of a first error to determine corrective information for remedying the first error, the first error responsive to a command generated by a large language model (LLM) responsive to prompting the LLM with a first input; and
provide the corrective information causing prompting of the LLM with a second input.
